(19) United States
(12) Patent Application Publication
(10) Pub. No.: US 2017/0341983 A1
(43) Pub. Date: Nov. 30, 2017

(54) Liquid Flow Aid for Dry Gunnables

(71) Applicant: Specialty Minerals (Michigan) Inc., Bingham Farms, MI (US)

(72) Inventors: Dominick Michael COLAVITO, Bangor, PA (US); Richard Charles GRIFFIN, Easton, PA (US); Douglas Lynn SHETLER, Bangor, PA (US)

(21) Appl. No.: 15/223,494

(22) Filed: Jul. 29, 2016

Related U.S. Application Data
(60) Provisional application No. 62/340,976, filed on May 24, 2016.

(51) Int. Cl. C04B 28/30; B05D 1/02; C04B 14/10; F27D 1/00; C04B 28/06; C04B 111/00

(52) U.S. Cl. CPC C04B 28/30; F27D 1/0003; C04B 28/06; B05D 1/02; C04B 14/10; C04B 2111/00431

(57) ABSTRACT

Embodiments of the present invention encompass methods of improving flow of dry materials. Embodiments of the present invention also encompass compositions with improved flow. Embodiments of the present invention also encompass methods of using the compositions with improved flow.

### CROSS-REFERENCE TO RELATED APPLICATION

This application claims the benefit of United States Provisional Patent Application No. 62/340,976, filed on May 24, 2016, and entitled “LIQUID FLOW AID FOR DRY GUNNABLES,” which is incorporated by reference herein in its entirety, expressly including any drawings.

### BACKGROUND

The present invention relates to a method for improving flow of dry materials and compositions with improved flow.

### INCORPORATION BY REFERENCE

All publications, patents, and patent applications mentioned in this specification are herein incorporated by reference to the same extent as if each individual publication, patent, or patent application was specifically and individually indicated to be incorporated by reference, and as if each said individual publication, patent, or patent application was fully set forth, including any figures, herein.

### SUMMARY

Embodiments of the present invention encompass methods of improving flow of dry materials.

Embodiments of the present invention also encompass compositions with improved flow.

Embodiments of the present invention also encompass compositions with improved dry flow.

Embodiments of the present invention encompass methods of providing a refractory material to a lining where the refractory composition applied has improved dry flow. In some embodiments, the lining is within a molten metal containing vessel.

### BRIEF DESCRIPTION OF THE DRAWINGS

FIGS. 1A, 1B, and 1C depict different views of an exemplary funnel which may be used to determine dry flow.

### DETAILED DESCRIPTION

The phrase “as used herein” encompasses all of the specification, the abstract, the drawings (figures), and the claims.

Use of the singular herein, including the specification, claims and drawings (figures), includes the plural and vice versa unless expressly stated to be otherwise. That is, “a,” “an” and “the” refer to one or more of whatever the word modifies. For example, “an article” may refer to one articles, two articles, etc. By the same token, words such as, without limitation, “articles” would refer to one article as well as to a plurality of articles unless it is expressly stated or obvious from the context that such is not intended.

As used herein, words of approximation such as, without limitation, “about,” “substantially,” “essentially,” and “approximately” mean that the word or phrase modified by the term need not be exactly that which is written but may vary from that written description to some extent. The extent to which the description may vary from the literal meaning of what is written, that is the absolute or perfect form, will depend on how great a change can be instituted and have one of ordinary skill in the art recognize the modified version as still having the properties, characteristics and capabilities of the modified word or phrase. With the preceding discussion in mind, in some embodiments, a numerical value herein that is modified by a word of approximation may vary from the stated value by ±15%, or ±10%, unless expressly stated otherwise.

As used herein, any ranges presented are inclusive of the end-points. For example, “a temperature between 10° C. and 30° C.” or “a temperature from 10° C. to 30° C.” includes 10° C. and 30° C., as well as any temperature in between.

As used herein, “wt %” is percent (%) by weight.

As used herein, a range may be expressed as from “about” one particular value and/or to “about” another particular value. When such a range is expressed, another embodiment is included, the embodiment being from one particular value and/or to the other particular value. Similarly when values are expressed as approximations by use of the antecedent “about,” it will be understood that the particular value forms another embodiment. As a non-limiting example, if “from about 1 to about 4” is disclosed, another embodiment is “from 1 to 4,” even if not expressly disclosed. Likewise, if one embodiment disclosed is a temperature of “about 30° C.,” then another embodiment is “30° C.,” even if not expressly disclosed.

Embodiments of the present invention encompass addition of a liquid to a solid material that improves dry flow. In some embodiments, the solid material is a blended granular mixture. In some embodiments, the method comprises blending the solid materials after the addition of the liquid. In some embodiments, the method further comprises allowing the solid materials with the added liquid to “age” for a time period before being subjected to dry flow where age means allow to stand without agitation. The aging may occur under conditions of temperature in the range of 0° C. to 40° C., or in the range of 10° C. to 25° C., with possible excursions of ±10° C., or in some cases, excursions of ±5° C. In some embodiments, the aging occurs under conditions of temperature in the range of 18° C. to 25° C. with possible excursions of ±10° C., or in some cases, excursions of ±5° C. The humidity may range from 20% to 90% relative humidity, or in some cases from 35% to 75% relative humidity. The atmospheric pressure may be normal atmospheric pressure or within 10% of normal atmospheric pressure where normal atmospheric pressure is 101.325 kilopascal (KPa), 29.92 inches Mercury (inHg), and 760 mm Mercury (mmHg). The time period may be 0.5 hour to 24 hours, and in some embodiments, the time period may be 1 hour to 18 hours. In some embodiments, the time period may be 1 hour to 7 days, 1 day to 7 days, and in some embodiments, the time period may be in the range of 1 hour to 3 hours, 1 hour to 8 hours, 2 hours to 8 hours, 2 hours to 12 hours, 2 hours to 18 hours, 2 hours to 24 hours, 4 hours to 8 hours, 4 hours to 12 hours, 4 hours to 16 hours, 4 hours to 24 hours, 4 hours to 30 hours, 4 hours to 36 hours, or 6 hours to 36 hours. In some embodiments, the liquid is essentially anhydrous when added to the dry material. In some embodiments, essentially anhydrous may be not more than 1 wt % water, not more than 0.5 wt % water, or not more than 0.1 wt % water.

Non-limiting examples of dry flow is the flow of materials through hoppers, silos, hopper/silo systems, and gun systems. Refractory linings are often produced or repaired with techniques known as gunning that utilize a gun system and these systems are generally well known. Non-limiting examples of gun systems include pneumatic gun systems, conventional pressure vessels such as “batch guns”, continuous feed guns, and fluidizing guns. Other non-limiting examples of gun systems are hopper/eductor systems. Embodiments of the present invention encompass other types of guns. In some embodiments, improved flow is gravity flow without the use of mechanical apparatus such as and without limitation flow without stirring, agitating, or vibrating.

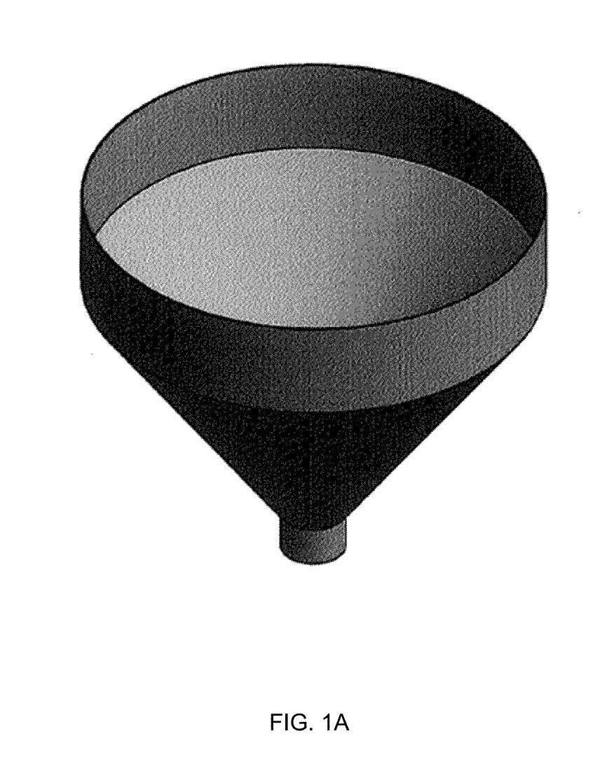

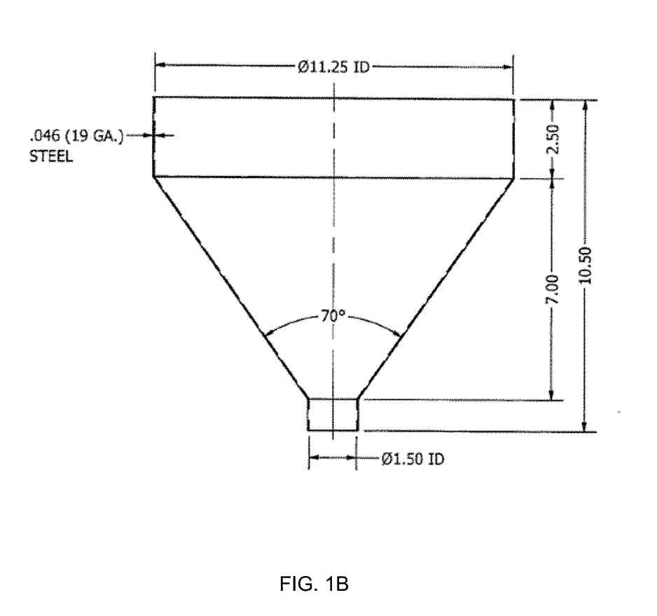

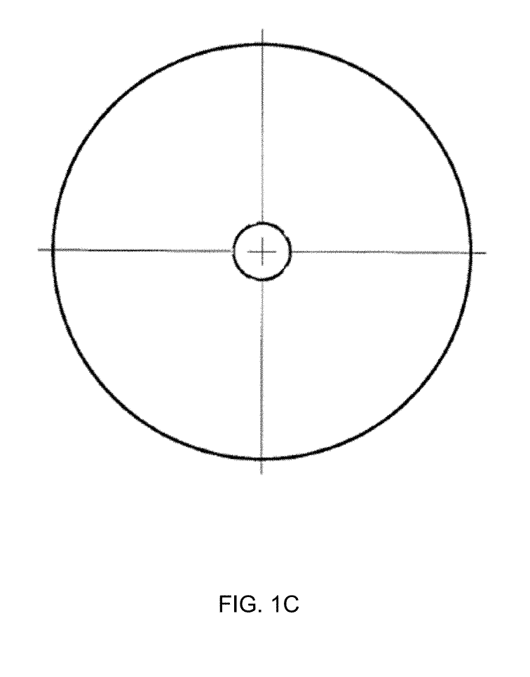

In some embodiments, improved dry flow is determined by timing the flow through a funnel, sometimes referred to as the test funnel. In some embodiments, the diameter of the discharge opening (smaller end) of the test funnel is about equal five (5) times the diameter of the largest grains in any material to be tested, or greater than five (5) times the diameter of the largest grains in any material to be tested. In preferred embodiments the diameter of the discharge opening of the test funnel is about equal to or greater than eight (8) times the diameter of the largest grains in any material to be tested. In some embodiments, improved dry flow is gravity flow through a funnel without the use of mechanical apparatus and/or without the use of mechanical agitation, such as and without limitation, flow without stirring, shaking, tapping, or vibrating. In some embodiments, the funnel may be a funnel such as that illustrated in FIGS. 1A, 1B, and 1C, which is essentially the frustum of a right circular cone with a short cylinder attached to each end. Specifically, for the funnel illustrated in FIGS. 1A, 1B, and 1C, the wide end is a cylinder of 11.25±0.0010 inches inner diameter and a height of 2.50±0.0010 inches, attached to the larger base of a frustum of a cone (the base being 11.25±0.0010 inches inner diameter) measuring 35° from the perpendicular which narrows to a smaller base of 1.50±0.0010 inches in inner diameter and is connected to a cylinder of 1.50±0.0010 inches inner diameter and a height of about 1 inch with the total height of the funnel being 10.50±0.0010 inches. In a non-limiting example, the funnel may be 0.046±0.005 inches in thickness and may formed from a metal such as steel (for example and without limitation 19 gage steel). As a non-limiting example, the smaller end (the discharge opening) of the funnel may be blocked with a stopper such as a rubber stopper, filled with a specific weight or volume of dry material based upon the size of the test funnel used, and the time for all of the material to flow out of the funnel once the stopper is removed may be measured. In some embodiments, improved dry flow is flow of a sample with a weight of 1-20 kilograms or a volume of 0.01 to 0.30 cubic feet (such as and without limitation, 3.0 Kilograms (Kg) or 2.75 to 3.25 Kg) through the funnel illustrated in FIGS. 1A, 1B, and 1C within 120 seconds, within 90 seconds, within 60 seconds, or within 45 seconds, without tapping or the use of a source of mechanical agitation and under gravity only (no vacuum at the bottom and no additional force or pressure at the top of the funnel). In some embodiments, improved dry flow is flow of a sample with a weight of 1-20 kilograms or a volume of 0.01 to 0.30 cubic feet (such as and without limitation, 3.0 Kg or 2.75 to 3.25 Kg) through the funnel illustrated in FIGS. 1A, 1B, and 1C within 40 seconds, within 30 seconds, within 25 seconds, or within 15 seconds, without tapping or other source of mechanical agitation and under gravity only (no vacuum at the bottom or additional force or pressure at the top of the funnel). In some embodiments, the flow of a sample with a weight of 1-20 kilograms or a volume of 0.01 to 0.30 cubic feet through the funnel illustrated in FIGS. 1A, 1B, and 1C is at least 0.1 seconds.

Non-limiting examples of the dry materials include gunnables, trowelables, castables, and shotcretables, etc. Other non-limiting examples of the dry materials include other dry materials that may be held in silos or pneumatic transfer vessels.

Non-limiting examples of dry materials include materials comprising magnesia, materials comprising alumina, materials comprising silica, and combinations thereof. Non-limiting examples of dry materials also include cement based refractory materials. Non-limiting examples of dry materials are refractory compositions including a refractory material, such as a magnesia based material, a silica based material, and/or an alumina based material. Examples of refractory materials include, without limitation, mullite, kyanite, magnesia, such as dead burned natural magnesite, synthetic periclase products derived from seawater or brine, dead burned dolomite, chrome ore grog, doloma or dolomite. The refractory material may include a plasticizer, a binder, a dispersant, and optionally, calcium carbonate, calcium oxide, and/or calcium hydroxide. Non-limiting examples of plasticizers include clays such as ball clay, kaolinite, bentonite, aluminum hydroxide, and starch. Non-limiting examples of binders, especially high temperature binders, include alkali phosphates such as sodium phosphate, potassium phosphate, ammonium phosphate, magnesium phosphate, calcium phosphate, and alkali silicates such as sodium silicate, potassium silicate, magnesium silicate, calcium silicate, calcium silicate cements, Portland cements, calcium aluminate cements, and sulfates such as sodium sulfate, potassium sulfate, magnesium sulfate, calcium sulfate, ammonium sulfate, zirconium sulfate, aluminum sulfate and sulfamic acid. Some other binders include starch, dextrin, various organic sulfonic acids and salts, and tars, pitches and resins. A non-limiting example of a dispersant is citric acid. For refractory compositions the binder is typically present in an amount of about 1 wt % to about 10 wt %, the plasticizer is typically present in amount of about 0.1 wt % to about 4 wt %, and the dispersant is typically present in an amount of about 0.1 wt % to about 1.5 wt % of the composition applied to form a refractory material and before the addition of water.

Embodiments of the present invention encompass a liquid added to improve dry flow and compositions comprising the liquid where the liquid has one or more of the following properties: a very low freezing point; a flash point above the boiling point of water; water miscible to some extent; and hygroscopic. In some embodiments, the liquid added is not hygroscopic, but has a very low freezing point, a flash point above the boiling point of water, is water miscible to some extent, or any combination thereof. In some embodiments, a very low freezing point is about −20° C. or less than −20° C. In some embodiments, a very low freezing point is about −40° C. or less than −40° C. In some embodiments, a very low freezing point is about −60° C. or less than −60° C. In some embodiments, water miscible to some extent means at least a 2 wt % solution with water (98 wt % water) may be formed at a temperature of 18° C. to 25° C. In some embodiments, water miscible to some extent means at least a 5 wt % solution with water (95 wt % water) may be formed at a temperature of 18° C. to 25° C. In some embodiments, water miscible to some extent means at least a 10 wt % solution with water (90 wt % water) may be formed at a temperature of 18° C. to 25° C. In some embodiments, hygroscopic means that after 15 minutes in an environment of at a temperature of 18° C. to 25° C. and a relative humidity in the range of 50% to 75% the weight of the material is increased by a least 2% [increase as a %=((final weight−initial weight)/initial weight)×100%].

The liquid added is not water added to a refractory material immediately prior to application to a lining such as the lining of a vessel, a furnace, or application to a wall, etc. The added liquid is not the water (or other fluid) mixed with the dry material during the application process.

Non-limiting examples of liquids used to improve dry flow in the embodiments of the present invention encompass the following:

1. Propylene glycol

2. Di, tri, tetra, etc. propylene glycol

3. Ethylene glycol

4. Di, tri, tetra, etc. ethylene glycol

5. Glycerol, including glycerin, etc.

6. Vegetable glycerin

7. Alkyl ethers of ethylene glycol or propylene glycol

8. Tetramethylene glycol

Liquids used to improve dry flow in the embodiments of the present invention, such as and without limitation, those described above, may be used individually or in combination. Other non-limiting examples of liquids which may be used in the embodiments of the present invention include ethylene glycol monomethyl ether (2-methoxyethanol, CH₃OCH₂CH₂OH), ethylene glycol monoethyl ether (2-ethoxyethanol, CH₃CH₂OCH₂CH₂OH), ethylene glycol monopropyl ether (2-propoxyethanol, CH₃CH₂CH₂OCH₂CH₂OH), ethylene glycol monoisopropyl ether (2-isopropoxyethanol, (CH₃)₂CHOCH₂CH₂OH), ethylene glycol monobutyl ether (2-butoxyethanol, CH₃CH₂CH₂CH₂OCH₂CH₂OH), ethylene glycol monophenyl ether (2-phenoxyethanol, C₆H₅OCH₂CH₂OH), ethylene glycol monobenzyl ether (2-benzyloxyethanol, C₆H₅CH₂OCH₂CH₂OH), diethylene glycol monomethyl ether (2-(2-methoxyethoxy)ethanol, CH₃OCH₂CH₂OCH₂CH₂OH), diethylene glycol monoethyl ether (2-(2-ethoxyethoxy)ethanol, CH₃CH₂OCH₂CH₂OCH₂CH₂OH), diethylene glycol mono-n-butyl ether (2-(2-butoxyethoxy)-ethanol, CH₃CH₂CH₂CH₂OCH₂CH₂OCH₂CH₂OH), ethylene glycol dimethyl ether (dimethoxy-ethane, CH₃OCH₂CH₂OCH₃), ethylene glycol diethyl ether (diethoxyethane, CH₃CH₂OCH₂CH₂OCH₂CH₃), ethylene glycol dibutyl ether (diethoxyethane, CH₃CH₂CH₂CH₂OCH₂CH₂OCH₂CH₂CH₂CH₃), ethylene glycol methyl ether acetate (2-methoxyethyl acetate, CH₃OCH₂CH₂OCOCH₃), ethylene glycol monoethyl ether acetate (2-ethoxyethyl acetate, CH₃CH₂OCH₂CH₂OCOCH₃), ethylene glycol monobutyl ether acetate (2-butoxyethyl acetate, CH₃CH₂CH₂CH₂OCH₂CH₂OCOCH₃), and propylene glycol methyl ether acetate (1-methyoxy-2-propanol acetate, CH₃CO₂CH(CH₃)CH₂OCH₃).

In some embodiments, the amount of liquid added is such that the final composition is in the range of 0.1 wt % to 0.8 wt %, preferably 0.15 wt % to 0.45 wt %, and more preferably, 0.2 wt % to 0.4 wt %. In some embodiments, the amount of liquid added 0.05 wt % to 0.35 wt %. In some embodiments, the amount of liquid added is 0.10 wt % to 1.2 wt %, and in some embodiments, the amount of liquid added is 0.1 wt % to 0.7 wt %. In some embodiments, the amount of liquid added is 0.1 wt % to 0.6 wt %, and in some embodiments, the amount of liquid added is 0.2 wt % to 0.5 wt %. In some embodiments, the amount of liquid added is 0.10 wt % to 0.35 wt %. In some embodiments, the amount of liquid added is in the range of 0.05 wt % to 0.3 wt %. In some embodiments, the amount of liquid added is in the range of 0.10 wt % to 0.3 wt %, and in some embodiments, the amount of liquid added is in the range of 0.10 wt % to 0.25 wt %.

As used herein, the amount of liquid in the final composition is determined as weight of the liquid added to the total weight (sum) of the liquid added and the dry materials, expressed as a percent. The “dry materials” may include residual moisture or other solvent as part of the as received materials. As a non-limiting example, 0.5 grams (or pounds (lbs)) propylene glycol added to 99.5 grams (or lbs) of dry material is 0.5 wt % propylene glycol. As noted the added liquid excludes water added prior to application or water added at the time of application.

In some embodiments, the liquid added is blended with the dry solid or granular/powder material via any conventional batch or continuous mixing system that would be used to blend dry granular/powder materials. In some embodiments, the liquid addition is distributed into the mixer/mixing system during the blending operation via a metering system including a pump and hose with or without a nozzle and the liquid is applied in a manner such that the liquid is spread out throughout the dry material to maximize distribution and prevent large clumps or balls of dry material from forming. In some embodiments, the liquid is added by geometric blending with the dry solid or granular/powder material. In some embodiments of the present invention, the mixing of the dry materials with the added liquid does not require any intense level of mixing or high level of shear for the liquid to be properly distributed and the effect of a subsequent improvement in dry flow to be exhibited. In some embodiments, the dry materials are blended together for some time period, and then the liquid is added by distributing the liquid across the surface of the dry material, and blending for an additional time period. As a non-limiting example, about 3 Kg of dry material may be added to a v-cone blender with an interior volume of about 5 liters, and the dry materials blended at a rotational speed of about 20 revolutions per minute for about 1.5 minutes. Then using a syringe containing a pre-determined quantity (weight or volume) of liquid, the liquid may be added by distributing the liquid over the surface of the dry material in the blender. Subsequently, the dry materials with added liquid may be blended at a rotational speed of about 20 revolutions per minute for about 1.5 minutes.

Embodiments of the present invention encompass a method of providing a refractory material to a lining comprising applying to the lining a refractory material where the refractory material is a refractory material with a liquid added as described herein, and optionally blending, aging, or both blending and aging the refractory material with the added liquid prior to application. In some embodiments, the refractory material is applied to the lining by gunning, spraying, casting, ramming, shotcreting, slurry coating, troweling, hot pouring, manual application, dry application or a hybrid method. In some embodiments, the lining is a lining of a furnace, or a vessel, such as and without limitation, a molten metal containing vessel.

Embodiments of the present invention encompass a method of providing a refractory material having a high density matrix to a lining in a molten metal containing vessel comprising applying to the lining a refractory material where the refractory material with a liquid added as described herein, and optionally blending, aging, or both blending and aging the refractory material with added liquid prior to application. In some embodiments, the refractory material is applied to the lining by gunning, spraying, casting, ramming, shotcreting, slurry coating, troweling, hot pouring, manual application, dry application or a hybrid method. Non-limiting examples of a refractory composition for application include those described in U.S. Pat. No. 7,078,360 B2, U.S. Pat. No. 8,257,485 B2, and U.S. Pat. No. 8,747,546 B2. In preferred embodiments, the refractory material is applied by gunning and the liquid is propylene glycol.

Embodiments of the present invention encompass a method of providing a refractory material to a non-metal contact surface, such as and without limitation, high temperature process furnaces, rotary kilns for mineral processing, reheat furnaces for solid steel shapes, cement coolers, petrochemical cyclones, incinerators, chimney stacks, protection wall, ash hoppers, heat shield, etc., or other substrate.

Non-limiting embodiments of the invention are described in the following paragraphs:

### Embodiment 1

A composition for providing a refractory material comprising a refractory material and a liquid at 0.1 to 0.8 wt % of the composition.

### Embodiment 2

A composition, such as that described in embodiment 1, wherein the liquid is 0.2 to 0.4 wt % of the composition.

### Embodiment 3

A composition, such as that described in embodiment 1 or embodiment 2, wherein the refractory material comprises magnesia, alumina, silica, or any combination thereof.

### Embodiment 4

A composition, such as those described in embodiments 1, 2, and 3, wherein the liquid is ethylene glycol, di-ethylene glycol, tri-ethylene glycol, propylene glycol, di-propylene glycol, tri-propylene glycol, glycerol, glycerin, an alkyl ether of ethylene glycol, an alkyl ether of propylene glycol, tetramethylene glycol, or any combination thereof.

### Embodiment 5

A composition, such as that described in embodiment 4, wherein the liquid is ethylene glycol, di-ethylene glycol, tri-ethylene glycol, propylene glycol, di-propylene glycol, tri-propylene glycol, glycerol, glycerin, or any combination thereof.

### Embodiment 6

A refractory composition comprising a refractory material; and a liquid, the liquid being 0.1 to 0.8 wt % of the composition.

### Embodiment 7

A refractory composition, such as that described in embodiment 6, wherein the liquid is 0.15 to 0.7 wt % of the composition.

### Embodiment 8

A refractory composition, such as that described in embodiment 7, wherein the liquid is 0.2 to 0.4 wt % of the composition.

### Embodiment 9

A refractory composition, such as those described in embodiments 6, 7, and 8, wherein the composition is for use in a vessel, a furnace, a kiln, a stack, a wall, or a hopper.

### Embodiment 10

A refractory composition, such as those described in embodiment 9, wherein the composition is for use in a vessel, and the vessel is a molten-metal containing vessel.

### Embodiment 11

A refractory composition, such as those described in embodiments 6-10, wherein the liquid is ethylene glycol, di-ethylene glycol, tri-ethylene glycol, propylene glycol, di-propylene glycol, tri-propylene glycol, glycerol, glycerin, an alkyl ether of ethylene glycol, an alkyl ether of propylene glycol, tetramethylene glycol, or any combination thereof.

### Embodiment 12

A refractory composition, such as that described in embodiment 11, wherein the liquid is ethylene glycol, di-ethylene glycol, tri-ethylene glycol, propylene glycol, di-propylene glycol, tri-propylene glycol, glycerol, glycerin, or any combination thereof.

### Embodiment 13

A refractory composition, such as those described in embodiments 6-12, wherein the composition is a gunning composition.

### Embodiment 14

A method for protecting a lining material in a molten-metal containing vessel comprising applying to the surface of the lining the refractory composition of any one of embodiments claim 6-13.

### Embodiment 15

A method for protecting a lining material comprising applying to the surface of the lining the refractory composition of any one of embodiments claim 6-13.

### Embodiment 16

A method, such as that described in embodiment 14 or 15, wherein the refractory composition is applied to the lining by gunning, spraying, casting, ramming, shotcreting, slurry coating, troweling, hot pouring, manual application, dry application or a hybrid method.

### Embodiment 17

A method, such as those described in embodiments 14 and 15, wherein the refractory composition is applied when the lining is hot.

### EXAMPLES

The following examples are given to aid in understanding the invention, but it is to be understood that the invention is not limited to the particular materials or procedures of the examples.

### Example 1

All ingredients in table 1 shown below were mixed by adding the dry materials to a dry mixer and then mixing for a total time of three (3) minutes. The liquid was added to the dry material in the dry mixer after an initial dry mixing cycle of 1.5 minutes with all dry materials added to the mixer. The liquid addition was then made to the mixer using a syringe with the pre-weighed liquid addition in the in the syringe by distributing the liquid across the surface of the dry material within the dry mixer. Following the liquid addition to the dry material a further mixing cycle of 1.5 minutes was completed. For samples with no liquid addition, the dry material was mixed for a single 3 minute cycle. The mixer used was a v-cone blender with an interior volume of about 5 liters and a rotational speed of about 20 revolutions per minute. The mixing of the dry materials with or without liquid addition does not require any intense level of mixing or high level of shear for the liquid to be properly distributed and subsequent improvement in dry flow to be in effect.

The formulations in Table 1A were optionally aged, and then tested for dry flow using a funnel like the funnel illustrated in FIGS. 1A, 1B, and 1C. The aging of samples was accomplished by allowing the sample to sit under conditions of temperature in the range of 20° C. to 22° C. with possible excursions of ±10° C., at 20% to 90% relative humidity, and at normal atmospheric pressure or within 10% of normal atmospheric pressure where normal atmospheric pressure is 101.325 KPa, 29.92 inches Mercury (inHg), and 760 mm Mercury (mmHg). For the dry flow test, a stopper is placed at the bottom of a funnel of the dimensions of the funnel illustrated in FIGS. 1A, 1B, and 1C, and the funnel is filled with a sample of 3.0 Kg of the dry powder blend. Then the stopper is removed and the time it takes for the dry powder to flow out is determined.

TABLE 1A
Formulations

Weight
Percent (wt %)

| Material | Description | 1A | 1B |
|---|---|---|---|
| Magnesia | 5 × 8 mesh | 28.00 | 28.00 |
| Magnesia | 8 × 18 mesh | 33.20 | 33.20 |
| Magnesia | −18 mesh | 5.30 | 4.95 |
| Magnesia | Fine powder | 29.00 | 29.00 |
| Sodium Silicate | Powder | 2.50 | 2.50 |
| Clay | Powder | 2.00 | 2.00 |
| Propylene Glycol | Liquid | 0.00 | 0.35 |

| | | |
|---|---|---|
| Total | 100.00 | 100.00 |

Table 1B provides the results of the flow test.

TABLE 1B
Dry Flow Test Results

| | 1A | | 1B | |
|---|---|---|---|---|
| Aging Time | Dry flow | | Dry flow | |
| (days) | time (s) | Need Tapping? | time (s) | Need Tapping? |
| 0 | 33 | Y | 22 | Y |
| 1 | 39 | Y | 11 | N |
| 2 | 33 | Y | 11 | N |
| 3 | 41 | Y | 10 | N |
| 5 | 36 | Y | 10 | N |

### Example 2

The formulations shown in Table 2A were made as described in Example 1, and optionally aged and tested as described in Example 1. The dry flow test results are shown in Table 2B.

TABLE 2A
Formulations

| | | Weight Percent (wt %) | | |
|---|---|---|---|---|
| Material | Description | 2A | 2B | 2C |
| Mullite | 4 × 8 mesh | 26.00 | 26.00 | 26.00 |
| Mullite | 8 × 20 mesh | 30.00 | 30.00 | 30.00 |
| Mullite | −20 mesh | 15.00 | 14.80 | 14.70 |
| Calcium Aluminate Cement | Powder | 8.00 | 8.00 | 8.00 |
| Kyanite | Powder | 19.00 | 19.00 | 19.00 |
| Clay | Powder | 2.00 | 2.00 | 2.00 |
| Propylene Glycol | Liquid | 0.00 | 0.20 | 0.30 |

| | | | |
|---|---|---|---|
| Total | 100.00 | 100.00 | 100.00 |

TABLE 2B
Dry Flow Test Results

| | 2A | | 2B | | 2C | |
|---|---|---|---|---|---|---|
| Aging | Dry | | Dry | | Dry | |
| Time | flow | Need | flow | Need | flow | Need |
| (hours) | time (s) | Tapping? | time (s) | Tapping? | time (s) | Tapping? |
| 0 | 29 | Y | n/a | n/a | n/a | n/a |
| 1 | 33 | Y | 33 | Y | 12 | Y |
| 2 | 32 | Y | 33 | Y | 15 | Y |
| 24 | 36 | Y | 13 | N | 13 | N |

### Example 3

The formulations shown in Table 3A were made as described in Example 1, and optionally aged and tested as described in Example 1. The dry flow test results are shown in Table 3B.

TABLE 3A
Formulations

| | | Weight Percent (wt %) | | | |
|---|---|---|---|---|---|
| Material | Description | 3A | 3B | 3C | 3D |
| Magnesia | 5 × 8 mesh | 25.00 | 25.00 | 25.00 | 25.00 |
| Magnesia | 8 × 18 mesh | 32.20 | 32.20 | 32.20 | 32.20 |
| Magnesia | −18 mesh | 5.40 | 5.00 | 5.00 | 5.00 |
| Magnesia | Fine powder | 32.40 | 32.40 | 32.40 | 32.40 |
| Sulfamic Acid | Powder | 3.00 | 3.00 | 3.00 | 3.00 |
| Calcium Hydroxide | Powder | 2.00 | 2.00 | 2.00 | 2.00 |
| Propylene Glycol | Liquid | 0.00 | 0.40 | 0.00 | 0.00 |
| Ethylene Glycol | Liquid | 0.00 | 0.00 | 0.40 | 0.00 |
| Glycerin | Liquid | 0.00 | 0.00 | 0.00 | 0.40 |

| | | | | |
|---|---|---|---|---|
| Total | 100.00 | 100.00 | 100.00 | 100.00 |

TABLE 3B
Dry Flow Test Results

| | 3A | | 3B | | 3C | | 3D | |
|---|---|---|---|---|---|---|---|---|
| Aging | Dry | | Dry | | Dry | | Dry | |
| Time | flow | Need | flow | Need | flow | Need | flow | Need |
| (hours) | time (s) | Tapping? | time (s) | Tapping? | time (s) | Tapping? | time (s) | Tapping? |
| 0 | 46 | Y | 9 | N | 9 | N | 8 | N |
| 1 | 42 | Y | 11 | N | 7 | N | 7 | N |
| 2 | 55 | Y | 8 | N | 9 | N | 42 | Y |
| 4 | 69 | Y | 11 | N | 9 | N | 8 | N |
| 24 | 62 | Y | 8 | N | 9 | N | 8 | N |

### Example 4

The formulations shown in Table 4A were made as described in Example 1, and optionally aged and tested as described in Example 1. The dry flow test results are shown in Table 4B.

TABLE 4A
Formulations

| | | Weight Percent (wt %) | | | |
|---|---|---|---|---|---|
| Material | Description | 4A | 4B | 4C | 4D |
| Magnesia | 5 × 8 mesh | 29.00 | 29.00 | 29.00 | 29.00 |
| Magnesia | 8 × 18 mesh | 30.00 | 30.00 | 30.00 | 30.00 |
| Magnesia | −18 mesh | 5.00 | 4.70 | 4.70 | 4.70 |
| Magnesia | Fine powder | 25.00 | 25.00 | 25.00 | 25.00 |
| Magnesia | Very fine | 5.00 | 5.00 | 5.00 | 5.00 |
| | powder | | | | |
| Sodium Phosphate | Powder | 3.00 | 3.00 | 3.00 | 3.00 |
| Calcium Hydroxide | Powder | 1.00 | 1.00 | 1.00 | 1.00 |
| Clay | Powder | 2.00 | 2.00 | 2.00 | 2.00 |
| Propylene Glycol | Liquid | 0.00 | 0.30 | 0.00 | 0.00 |
| Ethylene Glycol | Liquid | 0.00 | 0.00 | 0.30 | 0.00 |
| Tetraethylene | Liquid | 0.00 | 0.00 | 0.00 | 0.30 |
| Glycol | | | | | |

| | | | | |
|---|---|---|---|---|
| Total | 100.00 | 100.00 | 100.00 | 100.00 |

TABLE 4B
Dry Flow Test Results

| | 4A | | 4B | | 4C | | 4D | |
|---|---|---|---|---|---|---|---|---|
| Aging | Dry | | Dry | | Dry | | Dry | |
| Time | flow | Need | flow | Need | flow | Need | flow | Need |
| (hours) | time (s) | Tapping? | time (s) | Tapping? | time (s) | Tapping? | time (s) | Tapping? |
| 0 | 40 | Y | 35 | Y | 27 | Y | 32 | Y |
| 1 | 46 | Y | 9 | N | 29 | Y | 34 | Y |
| 2 | 39 | Y | 11 | N | 31 | Y | 28 | Y |
| 4 | 35 | Y | 14 | N | 33 | Y | 31 | Y |
| 24 | 46 | Y | 8 | N | 11 | N | 11 | N |

### Example 5

The formulations shown in Table 5A were made as described in Example 1, and optionally aged and tested as described in Example 1. The dry flow test results are shown in Table 5B.

TABLE 5A
Formulations

Weight
Percent (wt %)

| Material | Description | 5A | 5B |
|---|---|---|---|
| Magnesia | 5 × 8 mesh | 29.00 | 29.00 |
| Magnesia | 8 × 18 mesh | 30.00 | 30.00 |
| Magnesia | −18 mesh | 5.00 | 4.70 |
| Magnesia | Fine powder | 25.00 | 25.00 |
| Calcium Carbonate | Powder | 5.00 | 5.00 |
| Sodium Phosphate | Powder | 3.00 | 3.00 |
| Calcium Hydroxide | Powder | 1.00 | 1.00 |
| Clay | Powder | 2.00 | 2.00 |
| Propylene Glycol | Liquid | 0.00 | 0.30 |

| | | |
|---|---|---|
| Total | 100.00 | 100.00 |

TABLE 5B
Dry Flow Test Results

| | 5A | | 5B | |
|---|---|---|---|---|
| Aging Time | Dry flow | | Dry flow | |
| (hours) | time (s) | Need Tapping? | time (s) | Need Tapping? |
| 0 | 56 | Y | 48 | Y |
| 1 | 58 | Y | 25 | Y |
| 2 | 64 | Y | 42 | Y |
| 4 | 62 | Y | 14 | N |
| 24 | 69 | Y | 11 | N |
| 144 (6 Days) | 46 | Y | 12 | N |

Accordingly, it is understood that the above description of the present invention is susceptible to considerable modifications, changes and adaptations by those skilled in the art, and that such modifications, changes and adaptations are intended to be considered within the scope of the present invention.

What is claimed is:

1) A composition for providing a refractory material comprising:
a refractory material;
and
a liquid at 0.2 to 0.4 wt % of the composition.

2) The composition of claim 1, wherein the refractory material comprises magnesia, alumina, silica, or any combination thereof.

3) The composition of claim 1, wherein the liquid is ethylene glycol, di-ethylene glycol, tri-ethylene glycol, propylene glycol, di-propylene glycol, tri-propylene glycol, glycerol, glycerin, or any combination thereof.

4) The composition of claim 2 wherein the liquid is ethylene glycol, di-ethylene glycol, tri-ethylene glycol, propylene glycol, di-propylene glycol, tri-propylene glycol, glycerol, glycerin, or any combination thereof.

5) A refractory composition comprising:
a refractory material;
and
a liquid, the liquid being 0.2 to 0.8 wt % of the composition.

6) The composition of claim 5 wherein the liquid is 0.15% to 0.7 wt % of the composition.

7) The composition of claim 5 wherein the liquid is 0.2% to 0.4 wt % of the composition.

8) The composition of claim 5 wherein the composition is for use in a vessel.

9) The composition of claim 8 wherein the composition is for use in a molten-metal containing vessel.

10) The composition of claim 5, wherein the liquid is ethylene glycol, di-ethylene glycol, tri-ethylene glycol, propylene glycol, di-propylene glycol, tri-propylene glycol, glycerol, glycerin, or any combination thereof.

11) The composition of claim 8 wherein the liquid is ethylene glycol, di-ethylene glycol, tri-ethylene glycol, propylene glycol, di-propylene glycol, tri-propylene glycol, glycerol, glycerin, or any combination thereof.

12) The composition of claim 5, wherein the composition is a gunning composition.

13) A method for protecting a lining material in a vessel comprising applying to the surface of the lining the refractory composition of claim 5.

14) The method according to claim 13, wherein the vessel is a molten-metal containing vessel.

15) The method according to claim 13, wherein the refractory composition is applied to the lining by gunning, spraying, casting, ramming, shotcreting, slurry coating, troweling, hot pouring, manual application, dry application or a hybrid method.

16) The method according to claim 13, wherein the refractory composition is applied when the lining is hot.
